(19) United States
(12) Patent Application Publication
(10) Pub. No.: US 2025/0292605 A1
(43) Pub. Date: Sep. 18, 2025

(54) METHODS AND APPARATUSES FOR MULTI-CAMERA TRACKING

(71) Applicant: Tyco Fire & Security GmbH, Neuhausen am Rheinfall (CH)

(72) Inventors: Paul FEE, Belfast (GB); Terence NEILL, Lisburn (GB); William WRIGHT, Neuhausen am Rheinfall (CH)

(21) Appl. No.: 19/080,721

(22) Filed: Mar. 14, 2025

Related U.S. Application Data
(60) Provisional application No. 63/565,276, filed on Mar. 14, 2024.

(51) Int. Cl. G06V 30/14; G06F 21/32; G06V 10/82; G06V 30/19; G06V 40/16; G08B 21/22

(52) U.S. Cl. CPC G06V 30/1437; G06F 21/32; G06V 10/82; G06V 30/19073; G06V 30/19193; G08B 21/22; G06V 40/168

(57) ABSTRACT

Certain aspects of the present disclosure may include methods, systems, and non-transitory computer readable media for receiving one or more first images via a first camera associated with a first zone, identifying first features relating to a first object based on the one or more first images, receiving one or more second images via a second camera associated with a second zone, identifying second features relating to a second object based on the one or more second images, comparing the first features and the second features to generate a probability score indicating whether the first object is the same as the second object, determining, based on the probability score being higher than a threshold value, that the first object is the same as the second object, identifying the first object and the second object as the target object, and tracking the target object.

### CROSS REFERENCE TO RELATED APPLICATIONS

The current application claims priority to, and the benefit of, U.S. Provisional Application No. 63/565,276 filed on Mar. 14, 2024 and entitled “METHODS AND APPARATUSES FOR MULTI-CAMERA TRACKING,” the contents of which are hereby incorporated by reference in their entireties.

### TECHNICAL FIELD

Aspects of the present disclosure relate to tracking objects via multiple cameras.

### BACKGROUND

In some environments, an environment may be monitored by multiple cameras. Objects in the environment (e.g., people, vehicles, etc.) may move from the frame of one camera to another camera. It may be advantageous to track the objects for safety, security, and/or economical reasons. For example, security personnel at a venue may utilize the multiple cameras to track any suspicious people or packages. However, it may be difficult to track one or more objects moving across multiple cameras. Therefore, improvements may be desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Aspects of the present disclosure include receiving one or more first images via a first camera associated with a first zone, identifying first features relating to a first object based on the one or more first images, receiving one or more second images via a second camera associated with a second zone, identifying second features relating to a second object based on the one or more second images, comparing the first features and the second features to generate a probability score indicating whether the first object is the same as the second object, determining, based on the probability score being higher than a threshold value, that the first object is the same as the second object, identifying the first object and the second object as the target object, and tracking the target object.

### BRIEF DESCRIPTION OF THE DRAWINGS

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates an example of an environment for implementing integrated cameras for tracking objects in accordance with aspects of the present disclosure;

FIG. 2 illustrates an example of a method for training a neural network for image analytics in accordance with aspects of the present disclosure;

FIG. 3 illustrates an example method for implementing integrated cameras for tracking objects in accordance with aspects of the present disclosure; and

FIG. 4 illustrates an example of a computer system in accordance with aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

Objects may be easier to identify from certain directions. For example, it may be easier to recognize a person from their face compare to the back of their head. In an environment with multiple cameras (such as closed-circuit television (CCTV) cameras) with overlapping fields of view, an object may move from the view of one camera to another. To one camera, a person may be identifiable. However, to another camera, it may not have a view of sufficient identifying features to make a reliable identification. If a camera was aware of the arrangement of cameras and how their fields of view overlapped, the system could deduce that an object has moved from one camera to another. The identification and other analytics could then follow the object to the next (or previous) camera.

Artificial Intelligence (AI) assisted scene analysis may look at video from multiple cameras and deduce where the scenes overlap. For example, when a person walks through an airport, they may walk through the field of view of multiple cameras. On occasion they may be visible to more than one camera at a time. Aspects of the current disclosure would allow the otherwise independent object identifications to be brought to a multi-camera object tracking system. The tracking system may be used to track one or more objects from one camera to another camera. The analytics results from independent camera feeds may be brought together to give a more complete trajectory of an object.

For example, a person may have arrived at the airport by a blue taxi with license plate XYZ. The person may enter via door 5, face camera 3 (where face ID is feasible). The person may walk away from camera 4 (where a unique pattern on the back of their coat is recorded). Aspects of the present disclosure include analyzing the images of multiple cameras to allow for sophisticated metadata searches, such as finding a person that boarded flight ABC and arrived in a blue taxi.

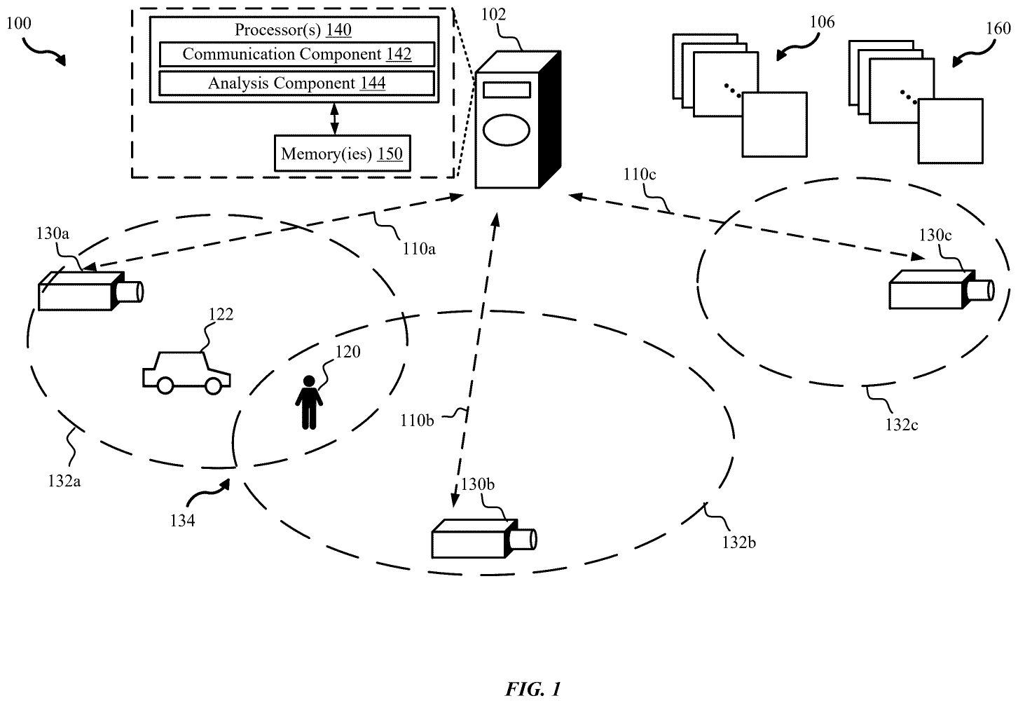

Referring to FIG. 1, in an aspect of the present disclosure, an example of an environment 100 for implementing integrated cameras for tracking objects is shown according to aspects of the present disclosure. The environment 100 may include a server 102 configured to receive, analyze, and/or transmit information relating to objects being tracked. The environment 100 may include cameras 130a-c configured to capture images of objects in the environment 100. The cameras 130a-c may include pan-tilt-zoom (PTZ) cameras, infrared cameras, surveillance cameras, or other suitable cameras. The cameras 130a-c may be deployed in the environment 100 (e.g., an infrastructure, a concert venue, a sports arena, a public transportation place, etc.). In some aspects, the cameras 130a-c may be configured to capture one or more images 106 of objects, such as people, cars, and/or personal belongings (e.g., purses, bags, etc.), etc., within the environment 100. The cameras 130a-c may be configured to transmit information associated with the one or more images 106 to the server 102, via communication channels 110a-c, for analysis as described below. The communication channels 110a-c may be wired and/or wireless communication links.

In some aspects, the server 102 may include one or more processors 140 configured to execute instructions stored in one or more memories 150 for performing the functions described herein. The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, controllers, digital signal processors (DSPs), field programmable gate arrays (FPGAs), programmable logic devices (PLDs), state machines, gated logic, discrete hardware circuits, and other suitable hardware configured to perform the various functionality described herein.

In some aspects, the server 102 may include the one or more memories 150. The one or more memories 150 may include software instructions and/or hardware instructions. The one or more processors 140 may execute the instructions to implement aspects of the present disclosure. The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

In certain aspects, the one or more processors 140 may include a communication component 142 configured to communicate with the cameras 130a-c and/or other external devices (not shown) using transceivers (not shown). The one or more processors 140 may include an analysis component 144 configured to analyze received information as described below.

During operation, the first camera 130a may monitor a first zone 132a in the environment 100. A person 120 and a vehicle 122 may be in the first zone 132a. The first camera 130a may captures images of the person 120 and/or the vehicle 122. The first camera 130a may transmit first images of the one or more images 106 associated with the person 120 and/or the vehicle 122 in the first zone 132a to the server 102. The communication component 142 of the server 102 may receive the first images of the one or more images 106.

In some aspects of the present disclosure, the analysis component 144 of the server 102 may analyze the first images of the one or more images 106. The analysis component 144 may identify features associated with the person 120 and/or the vehicle 122. The identified features may include colors, shapes, sizes, movement speeds, and/or other identifiable features. For example, for the person 120, the analysis component 144 may identify the height, clothing colors and/or types, presence/absence of accessories (e.g., bags, glasses, scarfs, or hats, etc.), types of accessories (if any), hair color(s), race/ethnicity, gait, build, etc. For the vehicle 122, the analysis component 144 may identify the colors, make, model, number of occupants, markings, dents, etc.

In some aspects, the analysis component 144 may identify interactions and/or relationship between objects. For example, the analysis component 144 may identify that the person 120 arrived at the environment 100 via the vehicle 122. The vehicle 122 may be parked in the first zone 132a.

In certain aspects, the analysis component 144 may store object files 160 (in the one or more memories 150) associated with objects identified by the analysis component 144. Here, the analysis component 144 may store a first object file associated with the person 120 in the first zone 132a. The analysis component 144 may store a second object file associated with the vehicle 122 in the first zone 132a.

In some aspects of the present disclosure, the person 120 may move from the first zone 132a to a second zone 132b. The second camera 130b may monitor the second zone 132b in the environment 100. The second camera 130b may captures images of the person 120 in the second zone 132b. The second camera 130b may transmit second images of the one or more images 106 associated with the person 120 in the second zone 132b to the server 102. The communication component 142 of the server 102 may receive the second images of the one or more images 106.

In some aspects of the present disclosure, the analysis component 144 of the server 102 may analyze the second images of the one or more images 106. The analysis component 144 may identify features associated with the person 120 as described above. The analysis component 144 may store a third object file associated with the person 120 in the second zone 132b.

In some aspects of the present disclosure, the person 120 may move from the second zone 132b to a third zone 132c. The third camera 130c may monitor the third zone 132c in the environment 100. The third camera 130c may captures images of the person 120 in the third zone 132c. The third camera 130c may transmit third images of the one or more images 106 associated with the person 120 in the third zone 132c to the server 102. The communication component 142 of the server 102 may receive the third images of the one or more images 106.

In some aspects of the present disclosure, the analysis component 144 of the server 102 may analyze the third images of the one or more images 106. The analysis component 144 may identify features associated with the person 120 as described above. The analysis component 144 may store a fourth object file associated with the person 120 in the third zone 132c.

In an aspect of the present disclosure, the first camera 130a, the second camera 130b, and/or the analysis component 144 may analyze the object files 160 to correlate objects in one zone (monitored by a camera) with objects in one or more same zones or other zones (monitored by one or more other cameras). In some aspects, the first camera 130a, the second camera 130b, and/or the analysis component 144 may compare identified features in two object files and generate a probability score that the objects identified in the two object files are the same. In one instance, the first camera 130a, the second camera 130b, and/or the analysis component 144 may generate the probability score based on a number of identified features in the two object files that are identical (e.g., both objects are people, with long blonde hair, wearing a blue jacket, being 6 feet tall, and carrying a handbag), and/or a number of identified features in the two object files that are different.

In a certain aspects, while the analysis of the one or more images 106 is performed in the analysis component 144 in FIG. 1, aspects of the present disclosure include performing image analysis in the cameras 130a-c, or in both the analysis component 144 and the cameras 130a-c.

In an example, the person 120 may exit the vehicle 122 in the first zone 132a. The first camera 130a may capture the first images of the person 120 and/or the vehicle 122. The first camera 130a may transmit the first images to the analysis component 144. The analysis component 144 may analyze the first images to determine that the person 120 is 5 feet tall, has short black hair, wears a blue suit and blue pants, and carries a computer bag. The analysis component 144 may generate the first object file associated with the person 120 in the first zone 132a.

In certain aspects, the person 120 may move from the first zone 132a to the second zone 132b. The second camera 130b may capture the second images of the person 120. The second camera 130b may transmit the second images to the analysis component 144. The analysis component 144 may analyze the second images to determine that the person 120 has short black hair, wears a blue suit and blue pants, and carries a computer bag. The analysis component 144 may not be able to determine the height of the person 120 from the second images. The analysis component 144 may generate the second object file associated with the person 120 in the second zone 132b.

In an aspect, the person 120 may move from the second zone 132b to the third zone 132c. The third camera 130c may capture the third images of the person 120. The third camera 130c may transmit the third images to the analysis component 144. The analysis component 144 may analyze the third images to determine that the person 120 wears a pair of sunglasses, has short black hair, wears a blue suit and blue pants, wears black shoes, and carries a computer bag. The analysis component 144 may not be able to determine the height of the person 120 from the third images, but may be able to determine additional information relating to the sunglasses and the black shoes. The analysis component 144 may generate the third object file associated with the person 120 in the second zone 132b.

In some aspects, the analysis component 144 may compare the first object file and the second object file. Based on the overlapping identified features (i.e., has short black hair, wears a blue suit and blue pants, and carries a computer bag) and/or nonoverlapping identified features (i.e., is 5 feet tall), the analysis component 144 may generate a probability score relating to whether the object in the first object file and the object in the second object file are identical. If the probability score exceeds a certain threshold (e.g., 60% certainty, 70% certainty, 80% certainty, 90% certainty, 95% certainty, or other threshold values), the analysis component 144 may determine that the two objects are identical. The threshold may be predetermined, programmed, or set using other suitable methods. Here, the analysis component 144 may determine that the two objects are identical, i.e., the person 120.

In certain aspects, the analysis component 144 may compare the second object file and the third object file. Based on the overlapping identified features (i.e., has short black hair, wears a blue suit and blue pants, and carries a computer bag) and/or nonoverlapping identified features (i.e., wears sunglasses and black shoes), the analysis component 144 may generate a probability score in a similar manner as above. Based on the probability score and the threshold, the analysis component 144 may determine that the two objects are identical, i.e., the person 120.

In an aspect, based on the determination above, the analysis component 144 may be able to track the person 120 moving from the first zone 132a, through the second zone 132b, and to the third zone 132c.

In some aspects, the analysis component 144 may adjust the probability score related to comparing the first object file and the second object file based on the person moving from the first zone 132a to the second zone 132b via an overlap region 134. Specifically, the first object file may include a first time that the person 120 is in the overlap region 134. The second object file may include a second time that the person 120 is in the overlap region 134. If the first time is substantially equal to the second time (i.e., within a threshold time difference), the analysis component 144 may increase the probability score that the object of the first object file is the same as the object in the second object file, i.e., the person 120.

In some aspects of the present disclosure, the analysis component 144 may track the person 120 for a variety of applications. In a first exemplary application, the analysis component 144 may track the person 120 to monitor whether the person 120 has entered any region that is prohibited to the person 120 (e.g., restricted area). For example, the person 120 may be permitted to access the first zone 132a and the second zone 132b, but not the third zone 132c. As such, in response to tracking the person to the third zone 132c, the analysis component 144 may take corrective actions such as sounding an alarm, alerting security personnel, performing a lockdown, etc.

In a second exemplary application, the analysis component 144 may track the person 120 to monitor whether the person 120 has remained in allowed regions. For example, the person 120 may be expected to reach the third zone 132c via the first zone 132a and the second zone 132b. However, there are unmonitored regions between the second zone 132b and the third zone 132c (i.e., no overlapping region for the cameras), and the unmonitored regions may include sub-regions that are prohibited to the person 120 (e.g., locked rooms). If the person exits the second zone 132b, but does not appear in the third zone 132c within a threshold time, the analysis component 144 may infer that the person has accessed or attempted to access the prohibited sub-regions and take corrective actions.

In a third exemplary application, the analysis component 144 may track the person 120 and objects associated with the person 120 (i.e., the vehicle 122). For example, the person 120 may have illegally parked the vehicle 122 and proceed to the third zone 132c. The analysis component 144 may identify the person 120 being the driver of the vehicle 122 and alerts the person 120 in the third zone 132c that the vehicle 122 is parked illegally.

Aspects of the present disclosure may include tracking an object using other identifying mechanisms such as biometric identification (e.g., facial, voice, fingerprint, iris, etc.), access device identification (e.g., key card, password, personal identification number (PIN), key fob, etc.), or other mechanism of tracking an object across multiple zones/regions. For example, the cameras 130a-c may be configured to perform facial recognition of the person 120. The facial features of the person 120 may be input into the object files after the facial recognition is performed on the captured images. In another example, the person 120 may enter authentication information (e.g., password and voice) to gain access to the second zone 132b and the third zone 132c. The analysis component 144 may determine the objects with the same authentication information in the second zone 132b and the third zone 132c as the same object, i.e., the person 120.

In one aspect of the present disclosure, the analysis component 144 may include an artificial intelligent engine (not shown) that may analyze the images using machine learning and/or a neural network as described below.

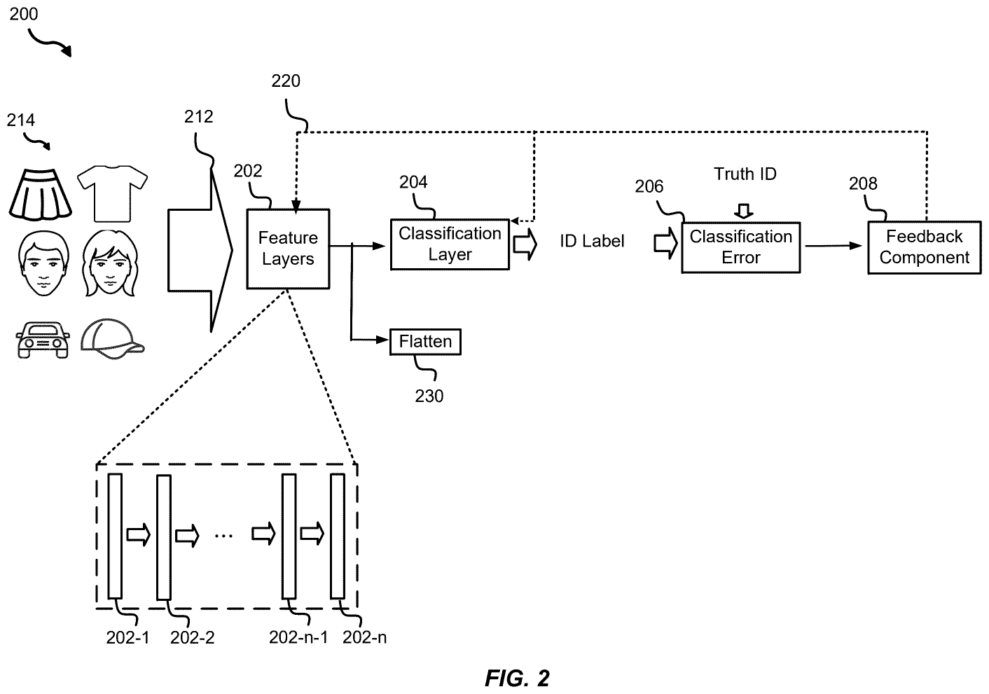

Turning to FIG. 2, an example of training a neural network 200 for identification may include feature layers 202 that receive training images 212 of features/objects/environment 214. The training images 212 may include images of the features/objects/environment 214 from different angles, under different lighting conditions, partial images of the features/objects/environment 214, etc. The feature layers 202 may be a deep learning algorithm that includes feature layers 202-1, 202-2 . . . , 202-n−1, 202-n. Each of the feature layers 202-1, 202-2 . . . , 202-n−1, 202-n may perform a different function and/or algorithm (e.g., pattern detection, transformation, feature extraction, etc.). In a non-limiting example, the feature layer 202-1 may identify edges of the training images 212, the feature layer 202-2 may identify corners of the training images 212, the feature layer 202-n−1 may perform a non-linear transformation, and the feature layer 202-n may perform a convolution. In another example, the feature layer 202-1 may apply an image filter to the training images 212, the feature layer 202-2 may perform a Fourier Transform to the training images 212, the feature layer 202-n−1 may perform an integration, and the feature layer 202-n may identify a vertical edge and/or a horizontal edge. Other implementations of the feature layers 202 may also be used to extract features of the training images 212.

In certain implementations, the output of the feature layers 202 may be provided as input to a classification layer 204. The classification layer 204 may be configured to identify the features (e.g., appearance, height, built, hair color, ethnicity, etc.), objects (e.g., accessories such as hats and glasses, clothing, and/or jewelry worn by the person 120), and/or environmental information (e.g., cars driven, potential witnesses, accomplices, etc.) associated with the person 120.

In some implementations, the classification layers 204 may output the ID label. A classification error component 206 may receive the ID label and a ground truth ID as input. The ground truth ID may be the “correct answer” provided by a trainer (not shown) to the neural network 200 during training. For example, the neural network 200 may compare the ID label to the ground truth ID to determine whether the classification layer 204 properly identifies the features/objects/environment associated with the ID label.

In some instances, the neural network 200 may include a feedback component 208. Based on the ID label and the ground truth ID, the classification error component 206 may output an error into the feedback component 208. The feedback component 208 may receive the error and provide one or more updated parameters 220 to the feature layers 202 and/or the classification layer 204. The one or more updated parameters 220 may include modifications to parameters and/or equations to reduce the error.

In some examples, the neural network 200 may include a flatten function 230 that generates a final output of the feature extraction step. For example, the flatten function 230 may be an operator that transforms a matrix of features into a vector. The output of the neural network 200 may include a vector describing the features/objects/environment.

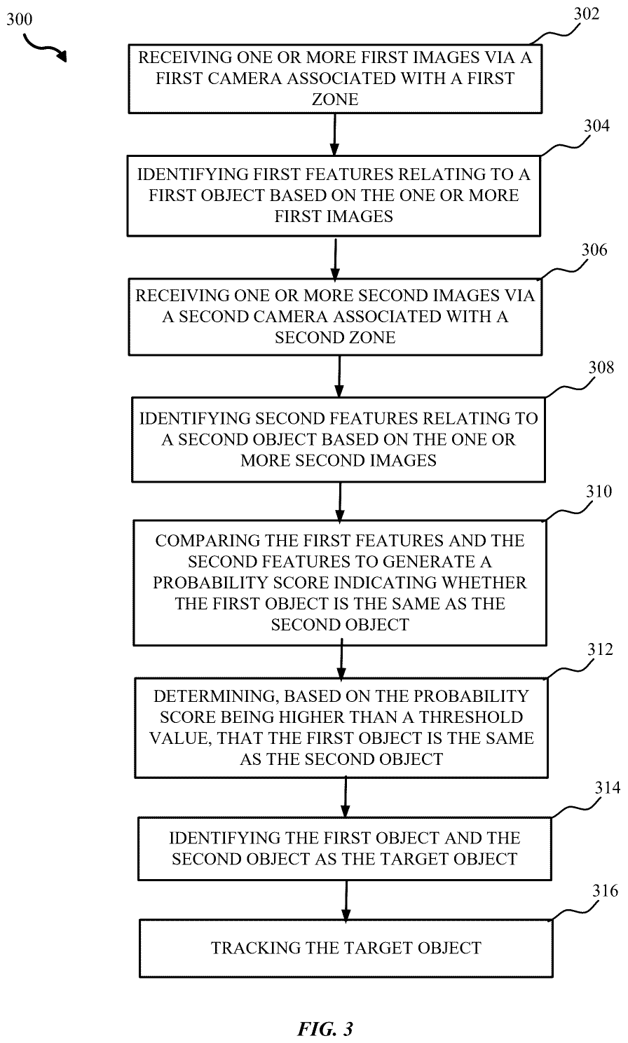

Turning to FIG. 3, an example of a method 300 for implementing integrated cameras may be implemented by the server 102, the cameras 130a-c, the one or more processors 140, the communication component 142, the analysis component 144, and/or the one or more memories 150. One or more of the server 102, the cameras 130a-c, the one or more processors 140, the communication component 142, the analysis component 144, and/or the one or more memories 150 may be configured to or provide means for implementing aspects of the method 300.

At block 302, the method 300 may receive one or more first images via a first camera associated with a first zone. The server 102, the one or more processors 140, the communication component 142, and/or the one or more memories 150 may be configured to or provide means for receiving one or more first images via a first camera associated with a first zone.

At block 304, the method 300 may identify first features relating to a first object based on the one or more first images. The server 102, the one or more processors 140, the analysis component 144, and/or the one or more memories 150 may be configured to or provide means for identifying first features relating to a first object based on the one or more first images.

At block 306, the method 300 may receive one or more second images via a second camera associated with a second zone. The server 102, the one or more processors 140, the communication component 142, and/or the one or more memories 150 may be configured to or provide means for receiving one or more second images via a second camera associated with a second zone.

At block 308, the method 300 may identify second features relating to a second object based on the one or more second images. The server 102, the one or more processors 140, the analysis component 144, and/or the one or more memories 150 may be configured to or provide means for identifying second features relating to a second object based on the one or more second images.

At block 310, the method 300 may compare the first features and the second features to generate a probability score indicating whether the first object is the same as the second object. The server 102, the one or more processors 140, the analysis component 144, and/or the one or more memories 150 may be configured to or provide means for comparing the first features and the second features to generate a probability score indicating whether the first object is the same as the second object.

At block 312, the method 300 may determine, based on the probability score being higher than a threshold value, that the first object is the same as the second object. The server 102, the one or more processors 140, the analysis component 144, and/or the one or more memories 150 may be configured to or provide means for determining, based on the probability score being higher than a threshold value, that the first object is the same as the second object.

At block 314, the method 300 may identify the first object and the second object as the target object. The server 102, the one or more processors 140, the analysis component 144, and/or the one or more memories 150 may be configured to or provide means for identifying the first object and the second object as the target object.

At block 316, the method 300 may track the target object. The server 102, the one or more processors 140, the analysis component 144, and/or the one or more memories 150 may be configured to or provide means for tracking the target object.

Aspects of the present disclosure include the method above, further comprising identifying an overlap region between the first zone and the second zone, identifying the first object, based on the one or more first images, in the overlap region at a first time, identifying the second object, based on the one or more second images, in the overlap region at a second time, determining that the first time is substantially equal to the second time, and increasing the probability score based on determining the first time being substantially equal to the second time.

Aspects of the present disclosure include any of the methods above, wherein identifying the first features and identifying the second features comprises identifying using a neural network.

Aspects of the present disclosure include any of the methods above, further comprising, in response to tracking the target object, identifying the target object entering into a prohibited region and taking a corrective action including one or more of sounding an alarm, alerting security personnel, or performing a lockdown of the prohibited region.

Aspects of the present disclosure include any of the methods above, wherein identifying the target object entering into the prohibited region comprises failing to identify the target object in an expected region within a threshold time.

Aspects of the present disclosure include any of the methods above, further comprising associating the target object with another object based on the one or more first images or the one or more second images.

Aspects of the present disclosure include any of the methods above, further comprising receiving a first authentication information associated with the first object, receiving a second authentication information associated with the second object, and wherein identifying the first object and the second object as the target object comprises identifying the first authentication information and the second authentication information being identical.

Aspects of the present disclosure include any of the methods above, wherein the first authentication information and the second authentication include one or more of a password, a personal identification number (PIN), key fob information, key card information, facial information, voice information, fingerprint information, or iris information.

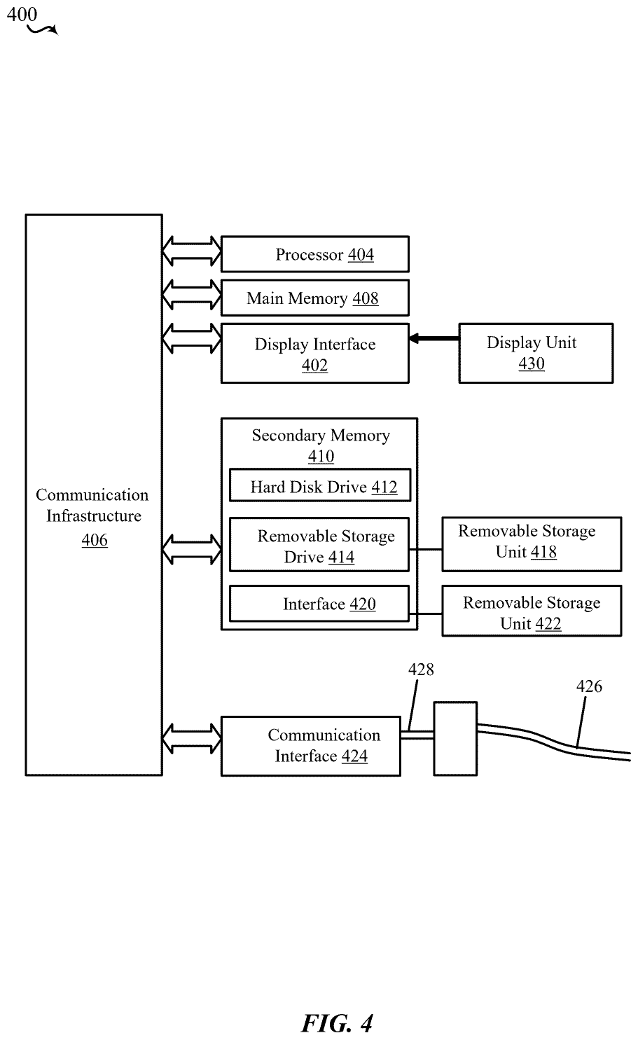

Aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 400 is shown in FIG. 4. In some examples, the server 102 and/or the cameras 130a-c may be implemented as the computer system 400 shown in FIG. 4. The server 102 and/or the cameras 130a-c may include some or all of the components of the computer system 400.

The computer system 400 includes one or more processors, such as processor 404. The processor 404 is connected with a communication infrastructure 406 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 400 may include a display interface 402 that forwards graphics, text, and other data from the communication infrastructure 406 (or from a frame buffer not shown) for display on a display unit 430. Computer system 400 also includes a main memory 408, preferably random access memory (RAM), and may also include a secondary memory 410. The secondary memory 410 may include, for example, a hard disk drive 412, and/or a removable storage drive 414, representing a floppy disk drive, a magnetic tape drive, an optical disk drive, a universal serial bus (USB) flash drive, etc. The removable storage drive 414 reads from and/or writes to a removable storage unit 418 in a well-known manner. Removable storage unit 418 represents a floppy disk, magnetic tape, optical disk, USB flash drive etc., which is read by and written to removable storage drive 414. As will be appreciated, the removable storage unit 418 includes a computer usable storage medium having stored therein computer software and/or data. In some examples, one or more of the main memory 408, the secondary memory 410, the removable storage unit 418, and/or the removable storage unit 422 may be a non-transitory memory.

Alternative aspects of the present disclosures may include secondary memory 410 and may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and the removable storage unit 422 and the interface 420, which allow software and data to be transferred from the removable storage unit 422 to computer system 400.

Computer system 400 may also include a communications circuit 424. The communications circuit 424 may allow software and data to be transferred between computer system 400 and external devices. Examples of the communications circuit 424 may include a modem, a network interface (such as an Ethernet card), a communications port, a Personal Computer Memory Card International Association (PCMCIA) slot and card, etc. Software and data transferred via the communications circuit 424 are in the form of signals 428, which may be electronic, electromagnetic, optical or other signals capable of being received by the communications circuit 424. These signals 428 are provided to the communications circuit 424 via a communications path (e.g., channel) 426. This communication path 426 carries signals 428 and may be implemented using wire or cable, fiber optics, a telephone line, a cellular link, an RF link and/or other communications channels. In this document, the terms “computer program medium” and “computer usable medium” are used to refer generally to media such as the removable storage unit 418, a hard disk installed in hard disk drive 412, and signals 428. These computer program products provide software to the computer system 400. Aspects of the present disclosures are directed to such computer program products.

Computer programs (also referred to as computer control logic) are stored in main memory 408 and/or secondary memory 410. Computer programs may also be received via communications circuit 424. Such computer programs, when executed, enable the computer system 400 to perform the features in accordance with aspects of the present disclosures, as discussed herein. In particular, the computer programs, when executed, enable the processor 404 to perform the features in accordance with aspects of the present disclosures. Accordingly, such computer programs represent controllers of the computer system 400.

In an aspect of the present disclosures where the method is implemented using software, the software may be stored in a computer program product and loaded into computer system 400 using removable storage drive 414, hard disk drive 412, or the interface 420. The control logic (software), when executed by the processor 404, causes the processor 404 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method for tracking a target object across multiple cameras, comprising:
receiving one or more first images via a first camera associated with a first zone;
identifying first features relating to a first object based on the one or more first images;
receiving one or more second images via a second camera associated with a second zone;
identifying second features relating to a second object based on the one or more second images;
comparing the first features and the second features to generate a probability score indicating whether the first object is the same as the second object;
determining, based on the probability score being higher than a threshold value, that the first object is the same as the second object;
identifying the first object and the second object as the target object; and
tracking the target object.

2. The method of claim 1, further comprising:
identifying an overlap region between the first zone and the second zone;
identifying the first object, based on the one or more first images, in the overlap region at a first time;
identifying the second object, based on the one or more second images, in the overlap region at a second time;
determining that the first time is substantially equal to the second time; and
increasing the probability score based on determining the first time being substantially equal to the second time.

3. The method of claim 1, wherein identifying the first features and identifying the second features comprises identifying using a neural network.

4. The method of claim 1, further comprising, in response to tracking the target object:
identifying the target object entering into a prohibited region; and
taking a corrective action including one or more of sounding an alarm, alerting security personnel, or performing a lockdown of the prohibited region.

5. The method of claim 4, wherein identifying the target object entering into the prohibited region comprises failing to identify the target object in an expected region within a threshold time.

6. The method of claim 1, further comprising associating the target object with another object based on the one or more first images or the one or more second images.

7. The method of claim 1, further comprising:
receiving a first authentication information associated with the first object; and
receiving a second authentication information associated with the second object;
wherein identifying the first object and the second object as the target object comprises identifying the first authentication information and the second authentication information being identical.

8. The method of claim 7, wherein the first authentication information and the second authentication information include one or more of a password, a personal identification number (PIN), key fob information, key card information, facial information, voice information, fingerprint information, or iris information.

9. A server for identifying a target object, comprising:
one or more memories including instructions; and
one or more processors communicatively coupled to the one or more memories and configured to execute the instructions to:
receive one or more first images via a first camera associated with a first zone;
identify first features relating to a first object based on the one or more first images;
receive one or more second images via a second camera associated with a second zone;
identify second features relating to a second object based on the one or more second images;
compare the first features and the second features to generate a probability score indicating whether the first object is the same as the second object;
determine, based on the probability score being higher than a threshold value, that the first object is the same as the second object;
identify the first object and the second object as the target object; and
track the target object.

10. The server of claim 9, wherein the one or more processors are further configured to:
identify an overlap region between the first zone and the second zone;
identify the first object, based on the one or more first images, in the overlap region at a first time;
identify the second object, based on the one or more second images, in the overlap region at a second time;
determine that the first time is substantially equal to the second time; and
increase the probability score based on determining the first time being substantially equal to the second time.

11. The server of claim 9, wherein the one or more processors are further configured to identify the first features and identifying the second features using a neural network.

12. The server of claim 9, wherein the one or more processors are further configured to, in response to tracking the target object:
identify the target object entering into a prohibited region; and
take a corrective action including one or more of sounding an alarm, alerting security personnel, or performing a lockdown of the prohibited region.

13. The server of claim 12, wherein the one or more processors are further configured to identify the target object entering into the prohibited region by failing to identify the target object in an expected region within a threshold time.

14. The server of claim 9, wherein the one or more processors are further configured to associate the target object with another object based on the one or more first images or the one or more second images.

15. The server of claim 9, wherein the one or more processors are further configured to:
receive a first authentication information associated with the first object; and
receive a second authentication information associated with the second object;
wherein identifying the first object and the second object as the target object comprises identifying the first authentication information and the second authentication information being identical.

16. The server of claim 15, wherein the first authentication information and the second authentication information include one or more of a password, a personal identification number (PIN), key fob information, key card information, facial information, voice information, fingerprint information, or iris information.

17. A non-transitory computer readable medium including instructions that, when executed by one or more processors of a server, cause the one or more processors to:
receive one or more first images via a first camera associated with a first zone;
identify first features relating to a first object based on the one or more first images;
receive one or more second images via a second camera associated with a second zone;
identify second features relating to a second object based on the one or more second images;
compare the first features and the second features to generate a probability score indicating whether the first object is the same as the second object;
determine, based on the probability score being higher than a threshold value, that the first object is the same as the second object;
identify the first object and the second object as the target object; and
track the target object.

18. The non-transitory computer readable medium of claim 17, further comprises instructions for:
identifying an overlap region between the first zone and the second zone;
identifying the first object, based on the one or more first images, in the overlap region at a first time;
identifying the second object, based on the one or more second images, in the overlap region at a second time;
determining that the first time is substantially equal to the second time; and
increasing the probability score based on determining the first time being substantially equal to the second time.

19. The non-transitory computer readable medium of claim 17, wherein the instructions for identifying the first features and identifying the second features comprises instructions for identifying using a neural network.

20. The non-transitory computer readable medium of claim 17, further comprises instructions for, in response to tracking the target object:
identifying the target object entering into a prohibited region; and
taking a corrective action including one or more of sounding an alarm, alerting security personnel, or performing a lockdown of the prohibited region.

21. The non-transitory computer readable medium of claim 20, wherein the instructions for identifying the target object entering into the prohibited region comprises instructions for failing to identify the target object in an expected region within a threshold time.

22. The non-transitory computer readable medium of claim 17, futher comprises instructions for associating the target object with another object based on the one or more first images or the one or more second images.

23. The non-transitory computer readable medium of claim 17, further comprises instructions for:
receiving a first authentication information associated with the first object; and
receiving a second authentication information associated with the second object;
wherein identifying the first object and the second object as the target object comprises identifying the first authentication information and the second authentication information being identical.

24. The non-transitory computer readable medium of claim 23, wherein the first authentication information and the second authentication information include one or more of a password, a personal identification number (PIN), key fob information, key card information, facial information, voice information, fingerprint information, or iris information.
